(19) United States
(12) Patent Application Publication
(10) Pub. No.: US 2024/0088606 A1
(43) Pub. Date: Mar. 14, 2024

(54) ELECTRICAL CONNECTOR WITH MAGNETIC LOCKING OF HOUSING PARTS ROTATABLE RELATIVE TO EACH OTHER

(71) Applicant: Phoenix Contact GmbH & Co. KG, Blomberg (DE)

(72) Inventors: Hrvoje Babic, Herrenberg (DE); Ralf Beckmann, Detmold (DE); Martin Schaefers, Paderborn (DE); Juergen Sahm, Ammerbuch (DE); Markus Hermann, Ammerbuch (DE); Markus Michel, Nagold (DE); Frank Brokmann, Detmold (DE); Holger Ritter, Wumberg (DE); Markus Hanses, Hoexter (DE)

(21) Appl. No.: 18/552,677

(22) PCT Filed: Mar. 25, 2022
(86) PCT No.: PCT/EP2022/057935

§ 371 Date: Sep. 27, 2023

(30) Foreign Application Priority Data
Mar. 29, 2021 (DE) DE102021107869.5
Jun. 29, 2021 (DE) DE102021116699.3

(51) Int. Cl. H01R 13/62; H01R 13/52; H01R 35/04

(52) U.S. Cl. CPC H01R 13/6205; H01R 13/5219; H01R 35/04

(57) ABSTRACT

An electrical connector includes: at least a first housing part and a second housing part, one of the first housing part and the second housing part engaging, at least partially and concentrically, in an other of the first housing part and the second housing part in an engagement region, the first housing part and the second housing part being rotatable relative to one another in the engagement region about an axis of rotation. The first housing part and the second housing part each have a magnetic structure extending, at least in part, circumferentially on an inside or an outside in the engagement region, the respective magnetic structures interacting.

### CROSS-REFERENCE TO PRIOR APPLICATIONS

This application is a U.S. National Phase application under 35 U.S.C. § 371 of International Application No. PCT/EP2022/057935, filed on Mar. 25, 2022, and claims benefit to German Patent Application No. DE 10 2021 107 869.5, filed on Mar. 29, 2021, and German Patent Application No. DE 10 2021 116 699.3, filed on Jun. 29, 2021. The International Application was published in German on Oct. 6, 2022 as WO/2022/207493 under PCT Article 21(2).

### FIELD

The invention relates to an electrical connector comprising at least a first housing part and a second housing part, one of the housing parts engaging, at least partially and concentrically, in the other housing part in an engagement region, and the first housing part and the second housing part being designed to be rotatable relative to one another in the engagement region about an axis of rotation.

### BACKGROUND

Electrical connectors which have two housing parts mounted so as to be rotatable relative to one another about a common axis of rotation, one housing part engaging in the other at least partially and the two housing parts being fixed, connected or similar to one another in the axial direction, that is to say parallel to the axis of rotation, are known from the prior art. A rotational joint is therefore arranged between the first housing part and the second housing part, the housing parts themselves typically being part of the rotational joint. This means that the rotational joint is not an explicit, separate element or component of the electrical connector, but is formed substantially by means of the two housing parts. One of the housing parts engages, in an engagement region, in an inner cavity in the other housing part. In this case, the housing parts are, at least in the engagement region, of rotationally symmetrical basic shape, each axis of rotational symmetry coinciding with the (common) axis of rotation. When one housing part enters or engages in the other housing part, the rotational symmetry relates in particular to the outer design thereof with regard to the outer circumferential wall in the engagement region and, with respect to the other housing part, in the inner cavity of which one of the housing parts engages or enters, relates in particular to the design of the inner cavity and to an inner wall surrounding the inner cavity. When one of the housing parts engages in the other housing part, the two housing parts are accordingly arranged concentrically with one another in the engagement region. Outside the engagement region, it is not necessary to restrict the design to the rotational symmetry of the housing parts or generally of the entire electrical connector of this type, optionally comprising further housing parts, further elements such as contact carriers for contacts, etc. In the axial direction parallel to the axis of rotation, the first and the second housing part are fixed to one another, for example by means of a circlip, and each engage, for example, on stops acting in the opposite direction on the two housing parts and/or engage in circumferential recesses on the inside or outside of the housing parts or the like. Such a design as that described above is known in particular from right-angle electrical connectors, in which either the first housing part or the second housing part is angled or is at least part of an angled electrical connector housing consisting of all the housing parts on one side of the rotational joint.

Mutually axially fixing the first housing part and the second housing part in parallel with the axis of rotation furthermore allows for free rotation of the two housing parts relative to one another about the axis of rotation. However, free rotatability about the axis of rotation is not necessarily desired and expedient, and therefore free rotatability is usually limited in practice, for example for the purpose of defined rotatability under certain circumstances, such as a certain external exertion of force in a direction of rotation about the axis of rotation. To this end, in the engagement region of the two housing parts, externally circumferential toothing or, generally, a surface structure with a similar effect can be provided for example on one of the housing parts, which is the inner housing part in the engagement region and engages in or enters the other housing part, and corresponding internally circumferential toothing or surface structure can be provided on the other housing part, which is the outer housing part in the engagement region, and in this way the respective toothings or the surface structures are in (usually permanently) mutual engagement. Free rotation of the housing parts relative to one another is then no longer possible, since this is blocked by the mutual engagement of the toothing or, generally, of the surface structures. When in mutual engagement, the toothing or surface structure produces, by means of respective locking positions, a number of possible (rest) positions for the two housing parts relative to each other with respect to the axis of rotation. In the case of a toothing, all teeth of the toothing of one housing part are then in the intermediate space between each two teeth of the toothing of the other housing part. Rotation of the housing parts relative to one another is then only still possible by applying a force in a direction of rotation about the axis of rotation, and in the process having to overcome the reversing forces of the toothings or surface structures which are in mutual engagement. In this case, the first housing part and the second housing part are optionally elastically deformed, primarily in the radial direction, at least in the respective surroundings of the toothings or surface structures at least until the next locking position or rest position is reached. In alternative embodiments, the toothing or, generally, the surface structures interact with a spring force in the axial direction, and, due to the spring force, the two housing parts are permanently under a certain amount of mechanical tension, even if no rotational movement occurs and the toothings are in a rest position or locking position.

Providing a toothing or, generally, a surface structure with a similar effect in order to limit and/or control the rotational movement of the first housing part and the second housing part relative to one another about the axis of rotation leads to a permanent load on the housing parts and to an additional, at least temporary, load on the housing parts during the transition between different locking positions when the housing parts are rotated relative to one another about the axis of rotation, which must be taken into account when designing the housing parts and, inter alia, restricts the choice of material for forming the housing parts or an electrical connector of this kind. In addition, the housing parts, when used, experience wear in the region of the toothing or surface structure over time due to the loads which occur when the housing parts are rotated relative to one another about the axis of rotation.

### SUMMARY

In an embodiment, the present invention provides an electrical connector, comprising: at least a first housing part and a second housing part, one of the first housing part and the second housing part engaging, at least partially and concentrically, in an other of the first housing part and the second housing part in an engagement region, the first housing part and the second housing part being configured to be rotatable relative to one another in the engagement region about an axis of rotation, wherein the first housing part and the second housing part each have a magnetic structure extending, at least in part, circumferentially on an inside or an outside in the engagement region, the respective magnetic structures being configured to interact.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is an exploded view of the essential elements of a variant of an electrical connector according to the invention; and

FIG. 2 is a detailed cut-out of the engagement region as part of a longitudinal sectional view of an electrical connector according to the invention in the assembled state according to FIG. 1.

### DETAILED DESCRIPTION

In an embodiment, the present invention provides an electrical connector having, between a first housing part and a second housing part, a rotational joint which is of alternative design and permits greater design freedom and higher, longer-lasting reliability.

Accordingly, the first housing part and the second housing part of an electrical connector according to the invention each have a magnetic structure extending, at least in part, circumferentially on the inside or outside in the engagement region, the respective magnetic structures being designed to interact.

A magnetic structure is to be understood in such a way that, at least in regions, magnetic moments are provided in a defined and structured manner on the first housing part and second housing part, in each case in the engagement region. This can be achieved, for example, by means of a magnetic coating or magnets. The magnetic structure is preferably ferromagnetic in nature and/or has a permanent magnetic field. Particularly preferably, individual segments, regions, parts or the like of a magnetic structure have well-defined magnetization and/or polarity. The magnetic field of a magnetic structure is therefore optionally to be understood as all the magnetic fields of the individual segments, regions, parts or the like of a magnetic structure. The magnetic structure does not have to be a coherent entity; the magnetic structure can consist of materially and spatially separate individual segments, regions or parts; by providing the individual segments, regions or parts in an overall view, a unique structure or pattern is formed, and in this way the magnetic structure can be understood in general abstract terms.

The magnetic structures provided on the two housing parts preferably interact in such a way that, by the magnetic fields of the magnetic structures influencing one another, the rotatability of the first and second housing part relative to one another about the axis of rotation is limited in a manner comparable with the surface structures known from the prior art, for example toothing. For this purpose, the magnetic structure can be, for example, in the form of segments, regions, parts or the like with alternating polarity arranged one after the other around the circumference. The magnetic structures of the two housing parts are coordinated with one another in such a way that two basic states result: In a first basic state, only segments, regions, parts or the like of each magnetic structure with the same magnetic pole are directly opposite one another, and in another, second basic state, only those with a different magnetic pole are directly opposite one another. In a first basic state, arranging identical magnetic poles opposite one another results in a force effect that attracts the segments, regions, parts or the like of the magnetic structures and thus of the magnetic structures on the two housing parts as a whole to one another. In a second basic state, arranging different magnetic poles opposite one another results in a repulsive force effect of the segments, regions, parts or the like of the magnetic structures and thus of the magnetic structures on the two housing parts toward each other as a whole. In order to rotate the first housing part and the second housing part relative to one another, proceeding from a first basic state, a force in the direction of rotation counter to the reversing forces (to a first basic state) must be applied due to the magnetic interactions between the magnetic structures of the first housing part and the second housing part. In a second basic state, the first housing part and the second housing part can be rotated virtually freely relative to one another, at least until a transition (back) into a first basic state occurs due to the rotation.

A first basic state corresponds here to the mutual locking of corresponding surface structures provided on the housing parts, such as are known from the prior art, for example toothings. In order to rotate the two housing parts about the axis of rotation relative to one another, proceeding from a first basic state corresponding to locking, a force must then be applied in a direction of rotation about the axis of rotation against the reversing forces between the magnetic structures on the first housing part and the second housing part, as already mentioned. A second basic state then corresponds to an intermediate state during the transition between two latching positions predetermined by the surface structures. The difference—and at the same time the advantage—in a solution according to the invention, as compared with the solutions known from the prior art, is that no deformation of the housing parts occurs and/or the housing parts are not permanently under mechanical tension either. The fact that the respective magnetic structures of the first housing part and the second housing part may touch, at least in part, does not contradict this. Mutual contact between at least parts of the respective magnetic structures of the first housing part and the second housing part can occur permanently or, for example, only in one or more specific states with respect to the rotatability of the first housing part and the second housing part relative to one another about the axis of rotation, for example in a first basic state.

In a preferred embodiment of an electrical connector according to the invention, the first housing part has, in the engagement region, a first annular surface which extends around the axis of rotation and has a surface normal that is parallel to the axis of rotation, and the second housing part has a corresponding second annular surface, the respective magnetic structures being provided on the annular surfaces. The annular surfaces can be formed, for example, as an abrupt change, in the axial direction, in the radius of an outer circumferential wall of the housing part which is the inner housing part in the engagement region, and a corresponding abrupt change, in the axial direction, in the radius of an inner circumferential wall of the housing part which is the outer housing part in the engagement region. A number of magnets in the form of thin plates or the like can then be arranged on each of the annular surfaces, for example.

According to a preferred variant of an electrical connector according to the invention, the first housing part has, in the engagement region, a first annular surface which extends around the axis of rotation and has a surface normal that is perpendicular to the axis of rotation, and the second housing part has a corresponding second annular surface, the respective magnetic structures being provided on the annular surfaces. In the case of the housing part which is the inner housing part in the engagement region, the annular surface can then be a circumferential outer wall or at least a (fully circumferential) part thereof and, in the case of the housing part which is the outer housing part in the engagement region, can be an inner circumferential wall or at least a (fully circumferential) part thereof, the respective annular surfaces of the first housing part and the second housing part being arranged in an identical axial position in the engagement region. A number of magnets in the form of thin plates or the like can then be arranged on each of the annular surfaces, for example. The number of corresponding thin plates or the like of the respective magnetic structures of the first housing part and the second housing part can be identical or different. By providing a different number of thin plates or the like as the magnetic structure of the first housing part and of the second housing part (approximately 12 plates on the first housing part and 13 plates on the second housing part), it is possible to provide a variant of an electrical connector according to the invention in which a uniform torque is produced with respect to the rotatability of the first housing part and the second housing part relative to one another about the axis of rotation. In this case, however, there are no first basic states and second basic states corresponding to conventional meshing toothing or the like of the first housing part and the second housing part. As an alternative to thin magnetic plates or the like, it is also possible to provide, as the magnetic structure, annular magnets with segmentally alternating magnetization or magnetic polarity, it being possible to precisely adapt the magnetization or polarity in accordance with the specific requirements for the particular electrical connector according to the invention (this is known as “programmable magnetization”).

According to a favorable variant of an electrical connector according to the invention, the first housing part has, in the engagement region, a first annular surface which extends around the axis of rotation and has surface normals that form an acute angle together with the axis of rotation, and the second housing part has a corresponding second annular surface, the respective magnetic structures being provided on the annular surfaces. Accordingly, an annular surface can, as an externally circumferential surface inclined/slanted with respect to the axis of rotation, be formed as part of an outer wall of the housing part which is the inner housing part in the engagement region, and, as an internally circumferential surface inclined/slanted with respect to the axis of rotation, be formed as part of an inner wall of the housing part which is the outer housing part in the engagement region. A number of magnets in the form of thin plates or the like can then be arranged on each of the annular surfaces, for example.

In a particularly favored variant of an electrical connector according to the invention, a circumferential sealing element is or can be arranged in a region at a connection end of the electrical connector, between the engaging housing part which engages, at least partially and concentrically, in the other housing part, and the other housing part, or between the other housing part and a securing element arranged on the engaging housing part. Accordingly, the sealing element also extends around the axis of rotation or around the (common) axes of rotational symmetry of the two housing parts. In the region of the connection end of an electrical connector according to the invention, the sealing element seals an intermediate cavity between the engaging housing part and the other housing part with respect to the external space. The potentially present securing element is considered here and in the following to implicitly be part of the engaging housing part and is not mentioned separately every time. Such a securing element is part of the mutual fixing of the two housing parts to each other in the axial direction parallel to the axis of rotation. If the sealing element is or can be arranged extending around the securing element, the securing element is arranged on the engaging housing part in the region of the connection end of the electrical connector and accordingly in the region of the connection end of the engaging housing part. However, alternative embodiments of an electrical connector according to the invention are also possible in which the/a securing element is not arranged in the region of the connection end of the electrical connector or of the engaging housing part and optionally the/a securing element is not explicitly arranged on the engaging housing part either. Accordingly, the sealing element then does not extend around the/a securing element, but rather around the engaging housing part.

A connection end of an electrical connector according to the invention is understood to be an end of the electrical connector which is provided for connection to a cable or to a device housing of a device or the like. In contrast thereto is at least one further, plug end of the electrical connector, which is designed to form a (plug-in) connection with a corresponding mating connector. If the connection end of an electrical connector according to the invention is provided for connection to a device housing or the like, the other housing part is typically designed in the manner of a base for fitting and (detachably) fixing to an outer side, for example the outer side of a housing wall, of a device housing or the like. In the region in which such an electrical connector is fitted to a device housing or the like, a recess or passage (through which electrical contacts, electrical conductors, etc. are guided) from an interior of the device housing or the like to an external space is provided on or in the device housing or the like. Advantageously, the sealing element arranged in a region at a connection end of such an electrical connector is then seated on the outside of the device housing or the like together with the other, base-like housing part, and borders the recess or passage, the sealing element being deformed when the other housing part or the electrical connector as a whole is fitted to the device housing or the like, since, for example, when not fitted to the device housing or the like, the sealing element projects somewhat beyond the other, base-like housing part on the connection side in the axial direction. The deformation causes the sealing element to better fill out a space between the two housing parts, in which the sealing element circumferentially extends between the two housing parts. As a result, a sealing effect which is usually already present due to the corresponding arrangement of the sealing element can be further improved in relation to the sealing effect of the intermediate cavity. When fitting a correspondingly designed electrical connector according to the invention to a device housing or the like, it is not primarily a question of sealing the intermediate cavity with respect to an external space against dirt or liquids that may enter from the external space, but in particular of sealing an inside (interior) of the device housing or the like with respect to the intermediate cavity in relation to impurities in the intermediate cavity. Rotational movements of the two housing parts relative to one another about the axis of rotation or the rotational joint between the two housing parts can result in abrasion which accumulates in the intermediate cavity and should preferably not enter a device housing or the like. This can be effectively prevented by the sealing element.

Furthermore, by means of the sealing element, a minimum radial distance can be ensured between the engaging housing part and the other housing part, at least in an environment around the connection end of an electrical connector according to the invention, and the engaging housing part can be guided better in the other housing part when the two housing parts rotate relative to one another about the axis of rotation, and this further improves the low-wear rotatability of the two housing parts relative to one another about the axis of rotation. The sealing element can also serve to damp vibrations. The sealing element is preferably designed as a shaped seal, for example as an O-Ring in a simple embodiment.

According to the invention, by alternately arranging magnets with different polarity, i.e., directly adjacent magnets have an opposite orientation of the connection axis from “north pole” and “south pole”, a catch is produced. As a result, a compact, low-wear variant of a rotational joint between a first housing part and a second housing part of an electrical connector can be provided, in which the two housing parts in question are additionally arranged in a tension-free manner or are fixed to one another in the axial direction. This opens up further degrees of freedom regarding the choice of materials for the housing parts in question.

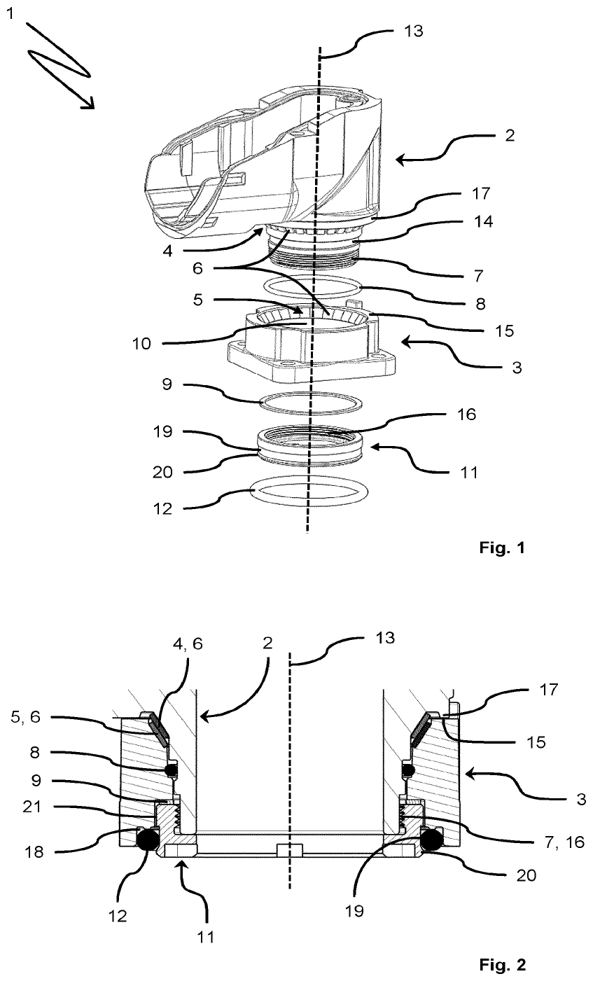

FIG. 1 is an exploded view of a variant of an electrical connector 1 according to the invention. The illustration only includes the most essential elements of the electrical connector 1, which is designed as a right-angle electrical connector. The electrical connector 1 comprises a first housing part 2 as part of a right-angle plug housing (not shown in full) and a second housing part 3, which is designed as a base or flange, so that the electrical connector 1 can be fitted via the second housing part 3, for example, to a (housing) wall of a device housing or the like and can be fastened to the wall, for example by means of screw connections.

The first housing part 2 and the second housing part 3 are rotatable relative to one another about an axis of rotation 13. If the second housing part 3 is fastened, as mentioned, to a device housing or the like, for example, only the first housing part 2 can be rotated about the axis of rotation 13 relative to the second housing part 3. In the assembled state, the first housing part 2—from the lower axial end with the circumferential external thread 7 up to the circumferential shoulder 17, formed as an abrupt enlargement of the outer radius of the first housing part 2 in the axial direction—engages in the inner cavity 10, which is located in the second housing part 3 and extends completely through the second housing part 3 in the axial direction. In this case, the bottom edge of the shoulder 17 forms a stop which rests on the upper edge 15 of the second housing part 3. In the region from the lower end of the first housing part 2 with the external thread 7 up to the shoulder 17, the first housing part 2 is rotationally symmetrical. Above the external thread 7, an outer circumferential constriction 14 for receiving an O-ring 8 is formed on the first housing part 2.

The shoulder 17 of the first housing part 2, as a stop, and the upper edge 15 of the second housing part 3, as a counter stop, form part of the axial fixation of the first housing part 2 and of the second housing part 3 to one another in parallel with the axis of rotation 13. The other part of the axial fixation comprises a plain bearing 9 and a fixing ring 11. The fixing ring 11 has an internal thread 16 corresponding to the external thread 7 of the first housing part 2 for forming a screw connection between the first housing part 2 and the fixing ring 11. Alternative embodiments of the invention provide differently designed connections, instead of the screw connection, between the first housing part 2 and the fixing ring 11, for example a bayonet connection, a press fit or a latching connection using a circlip. The plain bearing 9 is arranged between the top of the fixing ring 11 and a stop (not visible in FIG. 1) which is formed in the inner cavity 10 in the second housing part 3 as a circumferential abrupt reduction in the radius of the inner cavity 10 in the axial direction (as viewed from the lower axial end). The fixing ring 11, which is fastened to the first housing part 2 by means of a screw connection, the plain bearing 9 and the circumferential abrupt reduction in the radius of the inner cavity 10 in the axial direction as a stop for the plain bearing 9 and the fixing ring 11, together with the shoulder 17 of the first housing part 2 and the upper edge 15 of the second housing part 3, define the first housing part 2 and the second housing part 3 in both possible axial directions parallel to the axis of rotation 13.

A sealing element 12 designed as an O-Ring is arranged in a circumferential channel 18 which is open at the bottom, is not visible in FIG. 1 but is shown in FIG. 2 and is formed between the securing ring 11 and the second housing part 3. The channel 18 results from an internally circumferential recess in the radial direction in the second housing part 3 at the lower axial end thereof (which recess is not explicitly marked in FIG. 2 for reasons of clarity and is not visible at all in FIG. 1) and an externally circumferential constriction 19 on the securing element 11, which constriction is minor compared with the internally circumferential recess. In the axial direction, the channel 18 is substantially delimited by the abrupt change (increase) in the inner radius of the second housing part 3 caused by said internally circumferential recess in the radial direction in the second housing part 3. By means of the externally circumferential constriction 19 in combination with a radial projection 20 which is situated therebelow in the axial direction and extends outwards and around the outside of the securing element 11, an undercut 19, 20 is provided in the securing element 11 and prevents the sealing element 12 from falling out of the channel 18. With respect to the second housing part 3, the sealing element 12 protrudes a short distance from the channel 18 in the axial direction on the connection side and accordingly beyond the second housing part 3.

The lower axial end of the electrical connector 1 is designed as a connection end for connecting to a device housing or the like, i.e., for (external) fitting and (detachable) fixing to a wall of a device housing or the like. The second housing part 3 is therefore designed in the manner of a base or flange, as already discussed in a preceding section. When forming a connection to a device housing or the like, the electrical connector 1 is fitted in the region of a recess or passage (through which electrical contacts, electrical conductors, etc. are guided) in the housing wall from an interior of the device housing or the like to an external space. The axial end of the second housing part 3, which end is at the bottom in the drawings, is then seated on the outer side of the device housing, and the first housing part 1 or the securing element 11, which counts as part of the first housing part 1, then extends, not least because it extends in the axial direction at the connection end of the electrical connector 1, in any case a little way through and beyond the second housing part 3, into the recess or passage in the device housing or the like, specifically in such a way that the first housing part 1 has a slight tolerance or play in the radial direction and in particular does not impede the rotatability of the first housing part 1 with respect to the second housing part 3, which is then fixed to the device housing or the like, about the axis of rotation 13.

The sealing element 12 in this case extends around the edge of the recess or passage in the device housing or the like, in order, when the electrical connector 1 is fitted to the device housing or the like, to be pushed or pressed and deformed, together with the second housing part 2, into the channel 18. As a result, the sealing element 12 better fills out the channel 18 and, in particular in the region of the transition from the externally circumferential constriction 19 to the externally circumferential radial projection 20 on the securing element 12, presses more strongly radially inwards against the securing element 12 or the first housing part 2. This improves the sealing effect of the sealing element 12 with respect to the intermediate cavity 21. In the intermediate cavity 21 between the outer side of the first housing part 2 and the inner side of the second housing part 3, in the region in which the first housing part 3 engages in the second housing part 3 and which extends in the axial direction between the corresponding magnetic structures 4 and 5 at one end and the sealing element 12 at the other end, abrasion caused by friction between mutually touching regions or parts of the two housing parts 2, 3 during rotational movements of the first housing part 2 relative to the second housing part 3 about the axis of rotation 13 can accumulate in the intermediate cavity 21. This abrasion should not pass from the intermediate cavity 21 into a device housing or the like, and this can be effectively prevented, as described, by the sealing element 12 and the special arrangement of the sealing element 12 disclosed herein.

In addition, on account of the force exerted by the sealing element 12 in the radial direction both on the second housing part 3 and on the first housing part 2 as a result of the sealing element 12 being pressed into the channel 18, the sealing element 12 better supports, with respect to the second housing part 2, the first housing part 1 which engages in the second housing part 3 and, in the embodiment shown in the drawings, even extends therethrough. This further improves the ability of the first housing part 2 to rotate relative to the second housing part 3 about the axis of rotation 13 with low wear.

At the upper end of the second housing part 3, the radius of the inner cavity 10 is continuously (linearly) increased and an oblique, circumferential annular surface is formed on the inner wall of the second housing part 3, each surface normal at the annular surface forming an acute angle together with the axis of rotation 13. In contrast, alternative embodiments of the invention provide a shallow angle between the annular surface and the axis of rotation 13. Magnets 6 are arranged on the annular surface in the form of plates, the magnets 6 all being identical and placed equidistantly on the annular surface in the circumferential direction. The polarity of respective adjacent magnets 6 alternates. The described arrangement of the magnets 6 on the annular surface forms the magnetic structure 5 of the second housing part 3. A corresponding magnetic structure 4 is arranged on the first housing part 2. For this purpose, the first housing part 2 has, as a magnetic structure 4 of the first housing part 2, directly below the shoulder 17 a slanted annular surface or an annular surface inclined with respect to the axis of rotation 13, which is likewise equipped with equidistant identical magnets 6 in the circumferential direction, each surface normal at the annular surface forming an acute angle together with the axis of rotation 13. In alternative embodiments of the invention, there is no inclination of the annular surface with respect to the axis of rotation 13. Again, the polarity of magnets 6 directly adjacent in the circumferential direction alternates. The magnetic structure 4 of the first housing part 2 and the magnetic structure 5 of the second housing part 3 interact to some extent as a contactless means for locking the first housing part 2 and the second housing part 3 relative to one another with respect to a rotational movement of the first housing part 2 and the second housing part 3 relative to one another about the axis of rotation 13.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Electrical connector
2 First housing part
3 Second housing part
4 Magnetic structure of first housing part
5 Magnetic structure of second housing part
6 Magnets
7 External thread
8 O-ring
9 Plain bearing
10 Inner cavity of second housing part
11 Securing ring
12 Sealing element (O-ring)
13 Axis of rotation
14 Circumferential constriction
15 Upper edge of second housing part
16 Internal thread
17 Shoulder
18 Channel
19 Circumferential constriction
20 Radial projection
21 Intermediate cavity

1. An electrical connector, comprising:
at least a first housing part and a second housing part, one of the first housing part and the second housing part engaging, at least partially and concentrically, in an other of the first housing part and the second housing part in an engagement region, the first housing part and the second housing part being configured to be rotatable relative to one another in the engagement region about an axis of rotation,
wherein the first housing part and the second housing part each have a magnetic structure extending, at least in part, circumferentially on an inside or an outside in the engagement region, the respective magnetic structures being configured to interact.

2. The electrical connector of claim 1, wherein the first housing part has, in the engagement region, a first annular surface which extends around the axis of rotation and has a surface normal that is parallel to the axis of rotation, and the second housing part has a corresponding second annular surface, the respective magnetic structures being provided on the annular surfaces.

3. The electrical connector of claim 1, wherein the first housing part has, in the engagement region, a first annular surface which extends around the axis of rotation and has a surface normal that is perpendicular to the axis of rotation, and the second housing part has a corresponding second annular surface, the respective magnetic structures being provided on the annular surfaces.

4. The electrical connector of claim 1, wherein the first housing part has, in the engagement region, a first annular surface which extends around the axis of rotation and has surface normals that form an acute angle together with the axis of rotation, and the second housing part has a corresponding second annular surface, the respective magnetic structures being provided on the annular surfaces.

5. The electrical connector of claim 1, wherein a circumferential sealing element is arrangeable in a region at a connection end of the electrical connector, between the engaging housing part which engages, at least partially and concentrically, in the other housing part, and the other housing part, or between the other housing part and a securing element arranged on the engaging housing part.
